(19) United States
(12) Patent Application Publication
(10) Pub. No.: US 2005/0144071 A1
(43) Pub. Date: Jun. 30, 2005

(54) Method and apparatus to facilitate the electronic accumulation and redemption of a value in an account

(76) Inventors: Jay Monahan, Los Gatos, CA (US); Donald L. Albert, Saratoga, CA (US); Franck Chastagnol, Readwood City, CA (US); Peter Chu, Santa Clara, CA (US); Aaron Kwong Yue Lee, San Francisco, CA (US); Steve Chen, San Jose, CA (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/871,628

(22) Filed: Jun. 17, 2004

Related U.S. Application Data
(60) Provisional application No. 60/507,891, filed on Sep. 30, 2003.

(51) Int. Cl. G06F 17/60

(52) U.S. Cl. 705/14

(57) ABSTRACT

An automated system to facilitate redemption of value against a single purchase price includes a first module to allocate a first value, of a first value type, to a user within a transaction system. The first module is further to allocate a second value, of a second value type different from the first value type, to the user within the transaction system. A second module is to enable a user to redeem both the first value and the second value against a single purchase price.

The present application claims the priority benefit of U.S. provisional patent application No. 60/507,891, entitled “METHOD AND APPARATUS TO FACILITATE THE ELECTRONIC ACCUMULATION OF A VALUE IN AN ACCOUNT ASSOCIATED WITH A LOYALTY PROGRAM”, filed Sep. 30, 2003, the content of which is incorporated herein by reference.

### FIELD OF THE INVENTION

An embodiment relates generally to the technical field of commerce automation and, in one exemplary embodiment, to methods and systems to facilitate the electronic accumulation of value within an account.

### BACKGROUND OF THE INVENTION

Promotional campaigns and loyalty programs are typically used to incentivize purchasers to purchase a product (e.g., an item or a service) by offering the potential purchaser additional value in conjunction with a purchase of the relevant product. One way in which such additional value can be offered to a potential purchaser is by way of promotional (or loyalty) points, which may be accumulated by purchaser and then redeemed at some later time for something of value. The offering of such promotional points is attractive to an operator of a promotional campaign, as the relative value of each promotional point is low, and the purchaser is encouraged to make repeat purchases with a view to accumulation points. Once a purchaser has begun accumulation of promotional points, the purchaser is incentivized to continue such accumulation.

The widespread adoption of Internet technologies has encouraged the operators of promotional campaigns to use network-based technologies to facilitate such promotional campaigns. Specifically, network-based technologies provide a convenient mechanism for facilitating communications between a campaign operator and participants, and also provide a powerful platform for the automation of certain aspects of a promotional campaign. The automation of a promotional campaign, however, provides a number of technical challenges, as well as opportunities that require technical innovation.

### SUMMARY OF THE INVENTION

According one embodiment, there is provided an automated system to facilitate redemption of value against a single purchase price. The system includes a first module to allocate a first value, of a first value type, to a user within a transaction system. The first module is further to allocate a second value, of a second value type different from the first value type, to the user within the transaction system. A second module is to enable the user to redeem both the first value and the second value against the single purchase price.

According to a further embodiment, there is provided an automated system to facilitate accumulation of value in an account of a user. An accumulation module is to receive, from a user, first activity information regarding a first activity performed by the user and, responsive to receipt of the first activity information, to allocate a first value of a first value type to an account associated with the user. The accumulation module is further to receive, from the user, second activity information regarding a second activity performed by the user and, responsive to receipt of the second activity information, to allocate a second value of a second value type to the account associated with the user, the first and second value types being different value types. A redemption module is to enable the user to redeem the first and second values against a single purchase price.

Other aspects of the invention will become apparent from the detailed description in combination with the accompanying drawings.

### BRIEF DESCRIPTION OF THE DRAWINGS

The present invention is illustrated by way of example, and not limitation, in the figures of the accompanying drawings, in which like references indicate similar elements, and which:

FIG. 1 is a network diagram depicting a commerce system, according to an exemplary embodiment, having a client-server architecture.

FIG. 2 is a block diagram illustrating multiple marketplace and promotional applications that, in one exemplary embodiment, are provided as part of a network-based marketplace.

FIG. 3 is an entity-relationship diagram illustrating various tables that may be maintained within a database, according to one exemplary embodiment, that supports a network-based marketplace.

FIG. 4 shows various fields, according to an exemplary embodiment, that may be supported for each record within an items table maintained in the database.

FIG. 5 is a flowchart illustrating a method, according to an exemplary embodiment, to facilitate an automated accumulation of value (e.g., points, coupons, gift certificates, etc.) in an account of a user.

FIG. 6 is a flowchart illustrating a method, according to an exemplary embodiment, to redeem value (e.g., points, coupons, gift certificates) for goods or services.

FIG. 7 is a flowchart illustrating a method, according to an exemplary embodiment, to communicate activity information, pertaining to a loyalty/promotion program.

FIG. 8 illustrates a user interface, according to an exemplary embodiment, that may be communicated to provide reward input prompts to a user.

FIG. 9 illustrates an exemplary user interface that may be utilized to communicate individual and group point balances to a user.

FIG. 10 is a diagrammatic representation of the processing of multiple value types (e.g., points, coupons, gift certificates, etc.) by a redemption module, according to an exemplary embodiment.

FIG. 11 is a flowchart illustrating a method, according to an exemplary embodiment, to facilitate redemption of multiple values against a single purchase price (which may be with respect to multiple items).

FIG. 12 is a diagrammatic representation of a machine, in the exemplary form of a computer system, within which a set of instructions for causing the machine to perform any one of the methodologies discussed herein may be executed.

### DETAILED DESCRIPTION

A method and system to facilitate the electronic accumulation and redemption of value in an account, associated for example with a promotion or a loyalty program, are described. In the following description, for purposes of explanation, numerous specific details are set forth in order to provide a thorough understanding of the present invention. It will be evident, however, to one skilled in the art that the present invention may be practiced without these specific details.

Platform Architecture

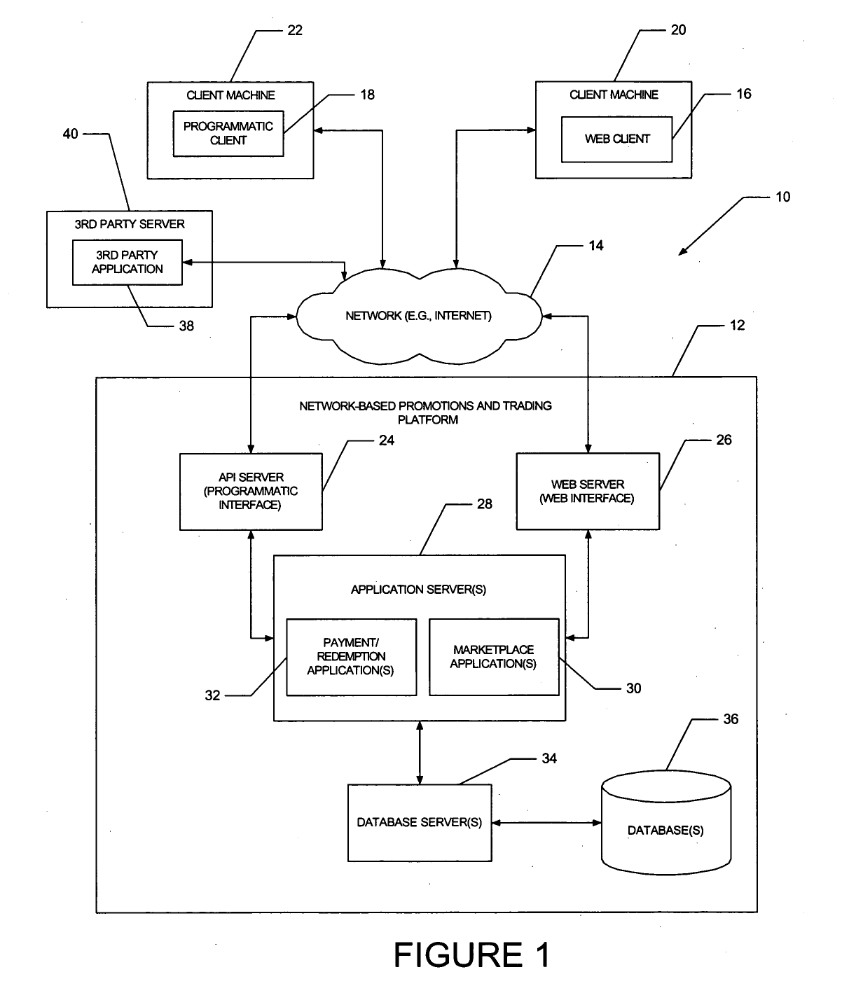

FIG. 1 is a network diagram depicting a commerce system 10, according to one exemplary embodiment, having a client-server architecture. Specifically, a promotion, loyalty and trading platform, in the exemplary form of a network-based marketplace 12, provides server-side functionality, via a network 14 (e.g., the Internet) to one or more clients. FIG. 1 illustrates, for example, a web client 16 (e.g., a browser, such as the Internet Explorer browser developed by Microsoft Corporation of Redmond, Wash. State), and a programmatic client 18 executing on respective client machines 20 and 22.

Turning specifically to the network-based marketplace 12, an Application Program Interface (API) server 24 and a web server 26 are coupled to, and provide programmatic and web interfaces respectively to, one or more application servers 28. The application servers 28 host one or more marketplace applications 30 and payment/redemption applications 32.

The application servers 28 are, in turn, shown to be coupled to one or more databases servers 34 that facilitate access to one or more databases 36.

The marketplace applications 30 provide a number of promotional, loyalty and marketplace functions and services to user that access the marketplace 12. The payment/redemption applications 32 likewise provide a number of payment and redemption services and functions to clients that access marketplace 12. Specifically, the payment/redemption applications 30 allow users to quantify for, and accumulate, value in accounts, and then later to redeem the accumulated value for products (e.g., goods or services) that are made available via the marketplace applications 30. While the marketplace and payment/redemption applications 30 and 32 are shown in FIG. 1 to both form part of the network-based marketplace 12, it will be appreciated that, in alternative embodiments, the payment/redemption applications 32 may form part of a promotion or loyalty service that is separate and distinct from the marketplace 12.

Further, while the system 10 shown in FIG. 1 employs a client-server architecture, the present invention is of course not limited to such an architecture, and could equally well find application in a distributed, or peer-to-peer, architecture system. The various marketplace and payment applications 30 and 32 could also be implemented as standalone software programs, which do not necessarily have networking capabilities.

The web client 16, it will be appreciated, accesses the various marketplace and payment/redemption applications 30 and 32 via the web interface supported by the web server 26. Similarly, the programmatic client 18 accesses the various services and functions provided by the marketplace and payment/redemption applications 30 and 32 via the programmatic interface provided by the API server 24. The programmatic client 18 may, for example, be a seller application (e.g., the TURBO LISTER application developed by eBay Inc., of San Jose, Calif.) to enable sellers to author and manage listings on the marketplace 12 in an off-line manner, and to perform batch-mode communications between the programmatic client 18 and the network-based marketplace 12.

FIG. 1 also illustrates a third party application 38, executing on a third party server machine 40, as having programmatic access to the network-based marketplace 12 via the programmatic interface provided by the API server 24. For example, the third party application 38 may, utilizing information retrieved from the network-based marketplace 12, support one or more features or functions on a website hosted by the third party. The third party website may, for example, provide one or more promotional, marketplace or payment/redemption functions that are supported by the relevant applications of the network-based marketplace 12.

Marketplace Applications

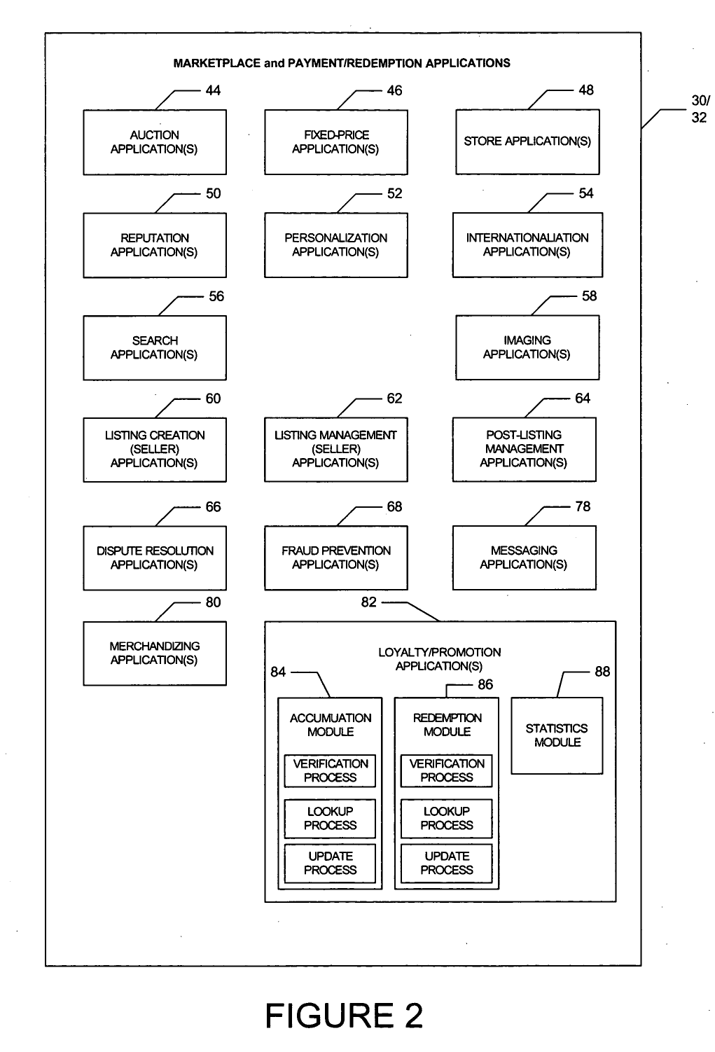

FIG. 2 is a block diagram illustrating multiple marketplace and promotional applications 30 that, in one exemplary embodiment, are provided as part of the network-based marketplace 12. The marketplace 12 may provide a number of listing and price-setting mechanisms whereby a seller can list goods or services for sale, a buyer can express interest in or indicate a desire to purchase such goods or services, and a price can be set for a transaction pertaining to the goods or services. To this end, the marketplace applications 30 are shown to include one or more auction applications 44 with support auction-format listings and price setting mechanisms (e.g., English, Dutch, Vickrey, Chinese, Double, Reverse auctions etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 46 support fixed-price listing formats (e.g., the traditional classified advertisement-type listing or a catalogue listing) and buyout-type listings. Specifically, buyout-type listings may be offered in conjunction with an auction-format listing, and allow a buyer to purchase goods or services, which are also being offered for sale via an auction, for a fixed-price which is typically higher than the starting price of the auction.

Store applications 48 allow sellers to group their listings within a “virtual” store, which may be branded and otherwise personalized by and for the sellers. Such a virtual store may also offer promotions, incentives and features that are specific and personalized to a relevant seller.

Reputation applications 50 allow parties that transact utilizing the network-based marketplace 12 to establish, build and maintain reputations, which may be made available and published to potential trading partners. Specifically, where the network-based marketplace 12 supports person-to-person trading, parties to a transaction may have no history or other reference information whereby trustworthiness and credibility may be ascertained. The reputation applications 50 allow a party, for example through feedback provided by other transaction partners, to establish a reputation over time within the network-based marketplace 12. Other potential trading partners may then reference such a reputation for the purposes of assessing credibility and trustworthiness.

Personalization applications 52 allow users of the marketplace 12 to personalize various aspects of their interactions with the marketplace 12. For example a user may, utilizing an appropriate personalization application 52, create a personalized reference page at which information regarding transactions to which the user has been a party may be viewed. Further, a personalization application 52 may enable a user to personalize listings and other aspects of their interactions with the marketplace 12 and other parties.

In one embodiment, the network-based marketplace 12 may support a number of marketplaces that are customized, for example for specific geographic regions. A version of the marketplace 12 may be customized for the United Kingdom, whereas another version of the marketplace 12 may be customized for the United States. Each of these versions may operate as an independent marketplace, or may be customized (or internationalized) presentations of a common underlying marketplace.

Navigation of the network based-marketplace 12 may be facilitated by one or more navigation applications 56. For example, a search application enables key word searches of listings published via the marketplace 12. A browse application allows users to browse various category, or catalogue, data structures according to which listings may be classified within the marketplace 12. Various other navigation applications may be provided to supplement the search and browsing applications.

In order to make listings available via the network-based marketplace 12 as visually informing and attractive as possible, the marketplace applications 30 may include one or more imaging applications 58 utilizing which users may upload images for inclusion within listings. An imaging application 58 also operates to incorporate images within viewed listings. The imaging applications 58 may also support one or more promotional features, such as image galleries that may be presented to potential buyers. For example, sellers may pay an additional fee to have an image associated with one or more of the listings included within a gallery of images for promoted items.

Listing creation applications 60 allow sellers conveniently to author listings pertaining to goods or services that they wish to transact via the marketplace 12, and listing management applications 62 allow sellers to manage such listings. Specifically, where a particular seller has authored and/or published a large number of listings, the management of such listings may present a challenge. The listing management applications 62 provide a number of features (e.g., auto-relisting, inventory level monitors, etc.) to assist the seller in managing such listings. One or more post-listing management applications 64 also assist sellers with a number of activities that typically occur post-listing. For example, upon completion of an auction facilitated by one or more auction applications 44, a seller may wish to leave feedback regarding a particular buyer. To this end, a post-listing management application 64 may provide an interface to one or more reputation applications 50, so as to allow the seller conveniently to provide feedback regarding multiple buyers to the reputation applications 50.

Dispute resolution applications 66 provide mechanisms whereby disputes that may arise between transacting parties may be resolved. Specifically, the dispute resolution applications 66 may provide guided procedures whereby the parties are guided through a number of steps in an attempt to settle the dispute. In the event that the dispute cannot be settled via the guided procedures, the dispute may be escalated to a third party mediator or arbitrator.

A number of fraud prevention applications 68 implement various fraud detection and prevention mechanisms to reduce the occurrence of fraud within the marketplace 12.

Messaging applications 78 are responsible for the generation and delivery of messages to users of the network-based marketplace 12, such messages for example advising users regarding the status of listings at the marketplace 12 (e.g., providing “outbid” notices to bidders during an auction process or to provide promotional and merchandising information to users).

Merchandising applications 80 support various merchandising functions that are made available to sellers to enable sellers to increase sales via the marketplace 12. The merchandising applications 80 also operate the various merchandising features that may be invoked by sellers, and may monitor and track the success of merchandising strategies employed by sellers.

The network-based marketplace 12 itself, or one or more parties that transact via the marketplace 12, may operate loyalty programs that are supported by one or more loyalty/promotions applications 82. For example, a buyer may earn loyalty or promotions points for each transaction established and/or concluded with a particular seller via the marketplace 12, and be offered a reward for which accumulated loyalty points can be redeemed. A user may also accumulate value in forms other than points. For example, value may be accumulated through coupons, gift certificates, etc.

The loyalty/promotion applications 82 include at least one accumulation module 84 that is responsible for registering the accumulation of value (e.g., points, coupons, gift certificates) within the accounts of users, and a redemption module 86 that is responsible for the redemption of accumulated value by users. Each of the accumulation and redemption modules 84 and 86 is shown to include a verification process, a lookup process, and an update process. The loyalty/promotion applications 82 also include a statistics module 88 that, as will be described in further detail below, is responsible for the generation of statistics pertaining to reward activities or events that may be registered with the loyalty/promotion applications 82.

Data Structures

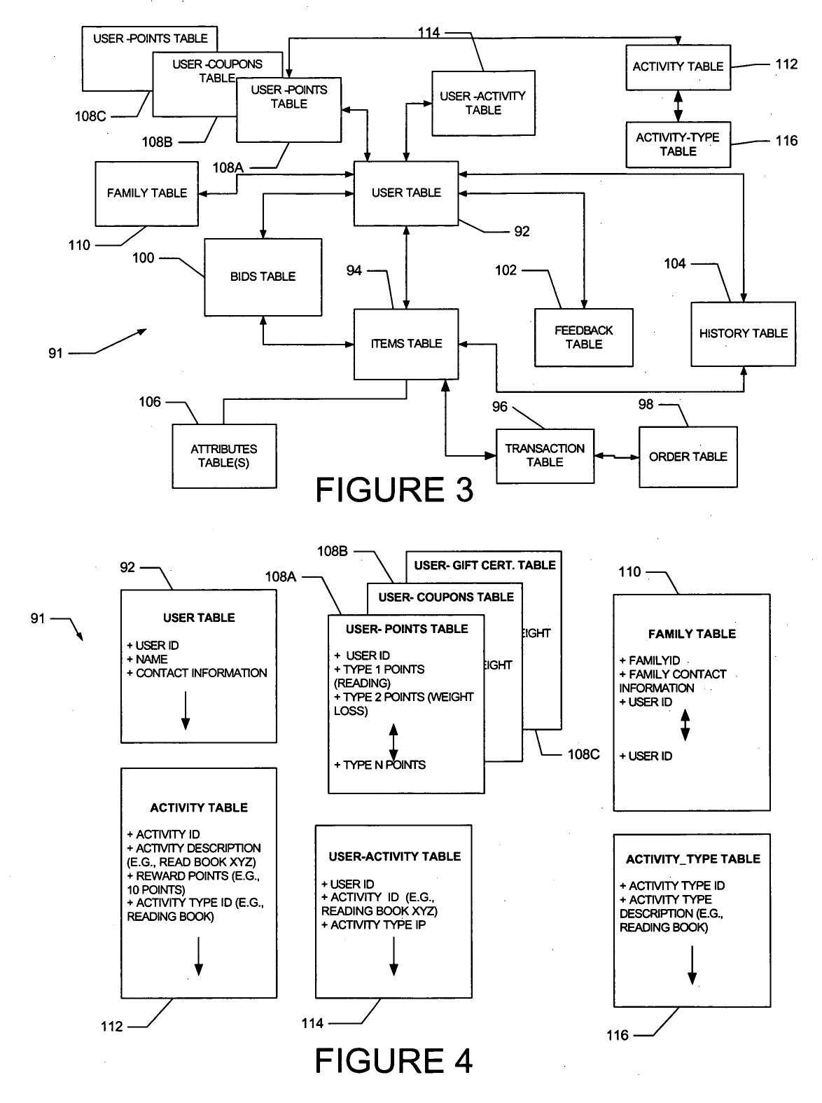

FIG. 3 is an entity-relationship diagram, illustrating various tables 91 that may be maintained within the databases 36, and that are utilized by and support the marketplace 12 and payment/redemption applications 30 and 32. A user table 92 contains a record for each registered user of the network-based marketplace 12, and may include identifier, address and financial instrument information pertaining to each such registered user. A user may, it will be appreciated, operate as a seller, a buyer, or both, within the network-based marketplace 12. In one exemplary embodiment of the present convention, a buyer may be a user that has accumulated value (e.g., promotional or loyalty points, coupons, gift certificates), and is then able to exchange the accumulated value for items that are offered for sale by the network-based marketplace 12.

The tables 90 also include an items table 94 in which is maintained an item record for each item or service that is available to be, or has been, transacted via the marketplace 12. Each item record within the items table 94 may furthermore be linked to one or more user records within the user table 92, so as to associate a seller and one or more actual or potential buyers with each item record. FIG. 4 shows various fields that may be supported for each record within the items table 94. In one exemplary embodiment, certain of the items for which records exist within the items table 94 may be promotional (or loyalty) items for which promotional or loyalty points (or other accumulated value) can be exchanged by a user.

A transaction table 96 contains a record for each transaction (e.g., a purchase transaction) pertaining to items for which records exist within the items table 94.

An order table 98 is populated with order records, each order record being associated with an order. Each order, in turn, may be with respect to one or more transactions for which records exist within the transactions table 96.

Bids records within a bids table 100 each relate to a bid receive at the network-based marketplace 12 in connection with an auction form of listing supported by an auction application 44. A feedback table 102 is utilized by one or more reputation applications 50, in one exemplary embodiment, to construct and maintain reputation information concerning users. A history table 104 maintains a history of transactions to which a user has been a party. One or more attributes tables 106 record attribute information pertaining to items for which records exist within the items table 94. Considering only a single example of such an attribute, the attributes tables 106 may indicate a currency attribute associated with a particular item.

FIG. 4 provides details regarding for the tables that are shown in FIG. 3 to be maintained within the databases 36. The tables discussed with reference to FIG. 4, in the exemplary embodiment, support one or more gift certificate, promotional or loyalty programs that may be made available by the marketplace 12. It will ever be appreciated that the invention is not limited to gift certificate, promotional or loyalty programs that operate as part of a marketplace 12. The components of the marketplace 12 that are described herein could also be deployed as a separate and distinct promotional or loyalty system, which communicates with a commerce and/or payment system to support the redemption of cumulative value.

Turning now specifically to the tables illustrated in FIG. 4, a user-value table, in the exemplary form of a points table 108A, maintains records of value accumulated by users, the accumulated values in the exemplary embodiment being represented by one or more types of points (e.g., loyalty or promotional points). The points may be regarded as a points-based currency and are exchangeable within the marketplace 12 for products (e.g., goods and services) that are offered for sale. The user-points table 108 is also shown to store point totals of different types, so that these point totals are distinguishable. The types attributed to the points totals may, in one exemplary embodiment, correlate to activities that were performed by user in order to acquire the relevant points. For example, the user-points table 108 is shown to include a reading points total, which reflects the total number of points that a user may have acquired as a result of reading activities performed by the user, and communicated to the loyalty applications 82 of the marketplace 12. Similarly, a weight loss points total reflects the total number of points that a user may have acquired as a result of weight loss goals achieved by the user.

In the exemplary embodiment described herein, each of the types of points is acquired under a single promotional or loyalty program for different activities or actions recognized by the relevant promotional or loyalty program as a reward (or value) generating events. In another exemplary embodiment, each of the types of points may be acquired and redeemed under separate and distinct promotional or loyalty programs. In another embodiment, each of the types of points may be acquired under distinct promotional or loyalty programs, but be redeemed across a number of promotional or loyalty programs. In yet another embodiment, the various types of point totals may constitute a global “currency”, and no distinction is made between the various types of points totals for acquisition and/or redemption purposes.

Also shown are a user-coupons table 108B, in which are maintained records of value accumulated by users as a result of received coupons, and a user-certificates table 108C, in which are maintained records of value accumulated by users as a result of received gift certificates.

A family table 110, in one exemplary embodiment, records various users of the marketplace 12 as constituting a family. In other embodiments, the family table 110 may be a group table that allows users to establish and register groups within the marketplace 12. One aspect proposes allowing members of a group (e.g., a family as identified in the family table 110) to pool accumulated value (e.g., points) for redemption or other purposes. The family table 110, as an example of a group table, is shown to store contact information for the relevant group and also the user identifiers of the various users that constitute the group.

An activity table 112 records various activities (or events or actions) that are recognized by one or more loyalty or promotional programs as being “reward” events, and accordingly that result in value (e.g., points) being attributed to a user. As shown, the activity table 112 includes records for a number of different types of activities, events or actions that may be regarded as “reward” events. Each “reward” events includes an activity identifier, an activity description (e.g., read book XYZ), a reward value (e.g., a number of points) associated with occurrence of the reward event, and an activity identifier (e.g., read book) associated with the relevant reward event. Accordingly, the activity table 112 may store separate records for a large number of activities, or reward events, of the same type but that are nonetheless distinguishable. For example, a separate record may be maintained for the reading of a particular book, and the reward value associated with the reading of the particular book may be different from the reward value associated with the reading of a different book. Similarly, a record may be maintained for a reward event that constitutes losing a predetermined amount of weight (e.g., expressed as a percentage of a total weight), and a particular reward value may be associated with that a reward event.

A user-activity table 114, in the exemplary embodiment, maps activities, for which records exist within the activity table 112, to a particular user for which a record exists within the user table 92.

An activity-type table 116 records the details for each of the activity types for which records exist within the activity table 112. Specifically, each record within the activity-type table 116 includes at least an activity type identifier, and an activity type description.

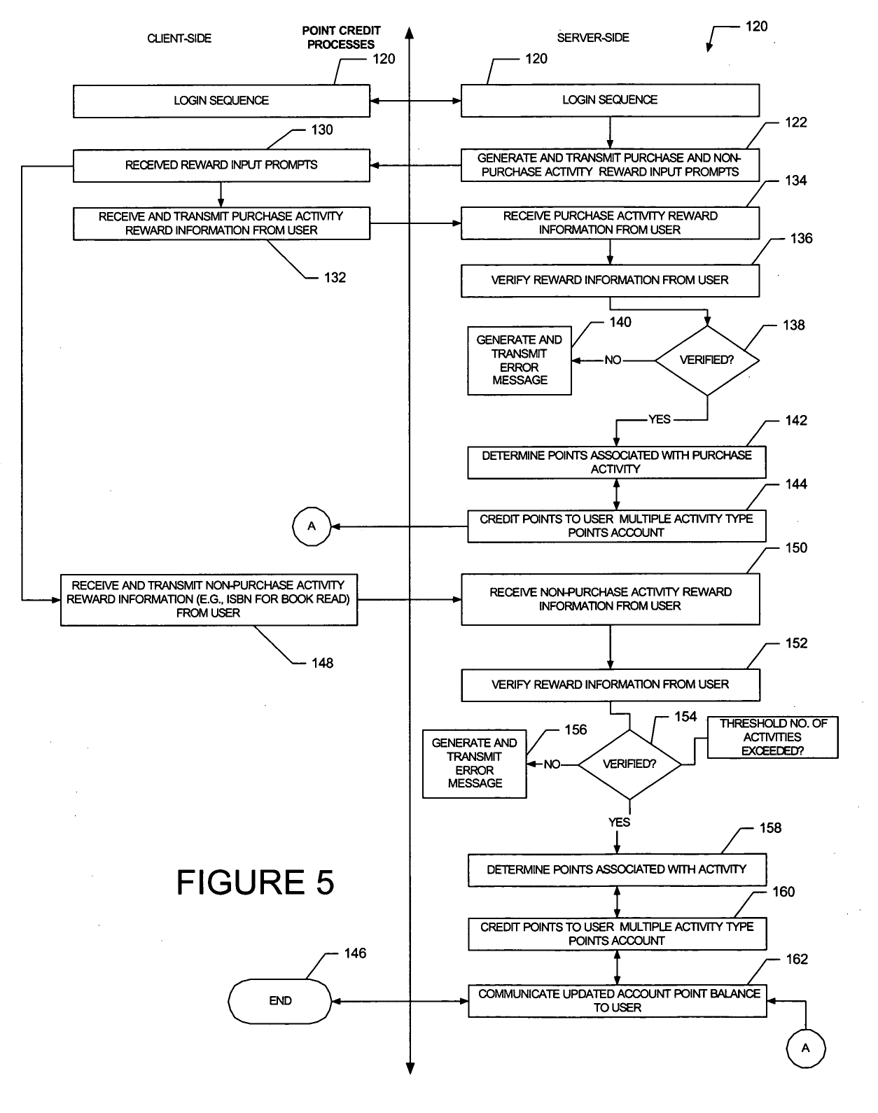

FIG. 5 is a flowchart illustrating a method 120, according to an exemplary embodiment, to facilitate the automated accumulation of value (e.g., points, coupons, etc.) in an account of the user. The method 120 may be utilized as a component of a promotions or loyalty program to facilitate the accumulation of value under the relevant program.

The method 120 commences with a login sequence 122, whereby user access to the network-based marketplace 12 is authenticated. Following the login sequence, at block 122, the loyalty/promotion applications 82, in conjunction with the web server 26, generate and transmit reward input prompts to a client machine 20. The reward input prompts may prompt the user to input both purchase and non-purchase activity information that a particular loyalty/promotion program. For example, the reward input prompt relating to a purchase activity might prompt the user to input a purchase code, the purchase code serving as evidence of a prior purchase by the user. A manufacturer and distributor of a particular product may include a purchase code on or within the packaging of a particular item sold by the manufacturer or distributor. The reward input prompt relating to the purchase activity prompts the user to input this purchase code.

The reward input prompt for a non-purchase activity may prompt the user to input activity reward information pertaining to some other activity performed by the user. For example, the user may be prompted to input the ISBN code identifying a book that the user (or a person associated with the user) has read. From the above discussion regarding activity types it will, however, be appreciated that the reward input prompts that are generated and transmitted at block 122 may be prompts for information relating to any two or more reward events that are of different types.

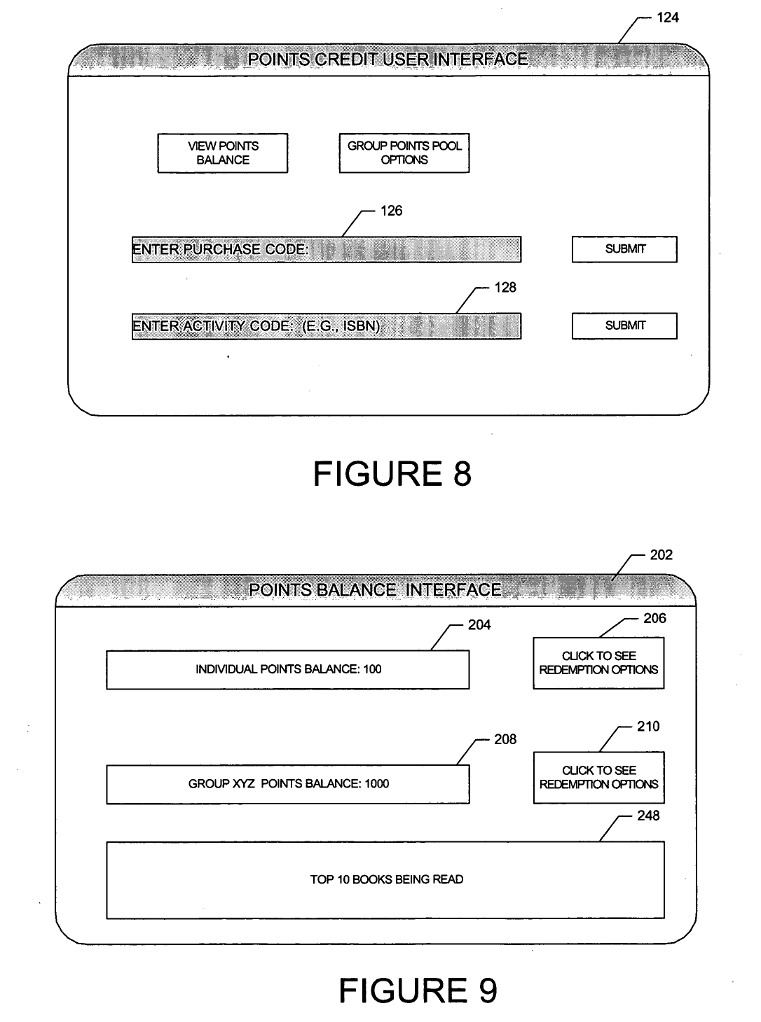

The transmitted reward input prompts may be included within a user interface 124, an exemplary embodiment of which is shown in FIG. 8, in the form of a mark-up language document that is generated and transmitted from the marketplace 12 to a client machine 20 for display by a web client 16 that is hosted on the relevant client machine 20. The interface 124 is shown to include a first purchase activity reward input prompt, in the exemplary form of the input field 126 into which the user may enter a purchase code, and a non-purchase activity reward input prompt, in the exemplary form of an input field 128 into which the user may enter the ISBN code of a book that has been read.

Returning to FIG. 5, at block 130, the reward input prompts are received and communicated to a user. For example, interface 124, described above with reference to FIG. 8, may be displayed to a user of a client machine 20.

FIG. 5 illustrates two flows that may result from the receiving of information, for example from a user, responsive to the communication of the reward input prompts to a user at block 130. While the two flows are shown separately to process purchase and non-purchase activity reward information, it will be appreciated that both types of activity reward information could be simultaneously communicated to the marketplace 12 via, for example the interface 24, in which case the processes described in the subsequent to block 130 may run substantially parallel. Alternatively, a user may only enter activity information for one type of activity, in which case only the pertinent flow would be executed.

Considering the situation where at least purchase activity reward information is received, the receipt and transmission of this purchase activity reward information is shown in FIG. 5 to occur at block 132. The purchase activity reward information is then received at the marketplace 12, and specifically at the loyalty/promotion applications 82, at block 134. At block 136, a verification process, that forms part of the accumulation module 84 of the loyalty/promotion applications 82, verifies the activity reward information received from the user. For example, where the purchase activity reward information is a purchase code, at block 136, the relevant verification process may access a database of valid purchase codes to determine whether the entered code is a valid and recognized code. In one embodiment, the verification process performed at block 136 may be performed by a lookup on the activity table 122, which may store a record, the purchase of a particular item being regarded as a distinct activity and having a distinct value (e.g., a predetermined number of points) associated therewith.

At decision block 138, a determination is made regarding the validity of the reward information from the user. In the event that the activity reward information is not verified, at block 140, an error message is generated and transmitted to the user.

On the other hand, following a successful verification, at block 142, the value (e.g., points) associated with the relevant purchase activity is determined. Again, this determination of the number of points associated with the identified purchase activity may be performed by an update process within the accumulation, via a lookup process, performs a lookup operation on the activity table 112 to determine the value (e.g., points) associated with the purchase activity.

At block 144, having determined the value associated with a particular purchase activity, the accumulation module 44 then evokes the update process to credit the relevant value to a user by updating an entry within the user-points table 108. The various point totals stored for a particular user within the user-points table 108, may be presented to the user as a multiple activity type points account, where multiple balances are reflected. Each balance reflects the points total, accumulated by the user for a particular activity type. The method 120 then progresses from block 144 to the end block 146, where the processing of the purchase activity information is completed.

Returning to block 130, non-purchase activity reward information (e.g., the ISBN code for a book that has been read) may be received at block 148 from the user responsive to the prompts presented at block 130. This non-purchase activity reward information is then also transmitted, from a client machine to the marketplace 12, at block 148.

At block 150, the non-purchase activity reward information is received at the server-side, whereafter a verification of the relevant reward information is performed at block 152. The verification of the non-purchase activity reward information, performed at block 152, may involve accessing an external database to verify certain values and other information included within the received reward information. For example, where the reward information includes the ISBN code of a book read, the verification of this information may involve perform a lookup on an external database of ISBN numbers to verify the validity of the ISBN number, and also to retrieve information regarding the reward activity (e.g., the bibliographic information regarding the book that has been read). In an alternative embodiment, the user could be subject to an automated test (e.g., a multiple choice quiz) regarding an activity alleged to have been performed. For example, a user may be quizzed regarding the content of a book.

The information retrieved from an external database to perform verification may, as will be further described below, be utilized to provide feedback to users, such as participants within a loyalty or promotional campaign, regarding activities that are being performed by other participants. For example, books that are most popular with participants in a promotional campaign may be identified using the retrieved information, and the most popular books may then be identified to all participants.

A further verification may be performed a block 154 with respect to the reward activity. For example, in terms of a particular promotion/loyalty campaign or program, a threshold number of reward activities that may be registered by a participant within a predetermined time period may be specified. For example, a user may be limited to registering a maximum of ten books within a one month time period. Accordingly, at decision block 154, a further verification may be made that a threshold number of reward activities have not been exceeded, or alternatively that a threshold number of reward activities needed to qualify the relevant reward activity have been performed.

In the event that the verification process fails, an error message is generated and transmitted to the client side at block 156. Alternatively, following a positive verification, at block 158, the reward value associated with the relevant non-purchase activity is determined by having the accumulation module 84 perform a lookup, utilizing a lookup process, on the activity table 122. As described above, the reading of a particular book identified by the ISBN code entered by a user, may be regarded as a specific and discrete activity having a predetermined reward value associated therewith.

At block 160, the accumulation module 84 then proceeds to credit the relevant value to a user account, for example, supported by the user-points table 108. Again, the accumulation of the value may be specific to a particular type of activity (e.g., reading books), and the accumulated value is distinguishable within the user account from accumulated value acquired through other types of activities.

At block 162, the updated point totals, as reflected within the user-points table 108, may be communicated to the user as updated account point balances, each of the balances pertaining to a separate activity type. Of course, in alternative embodiment, points generated from various different types of reward events may simply contribute towards a single points total that is communicated to the user at block 162.

The method 120 then terminates at block 146.

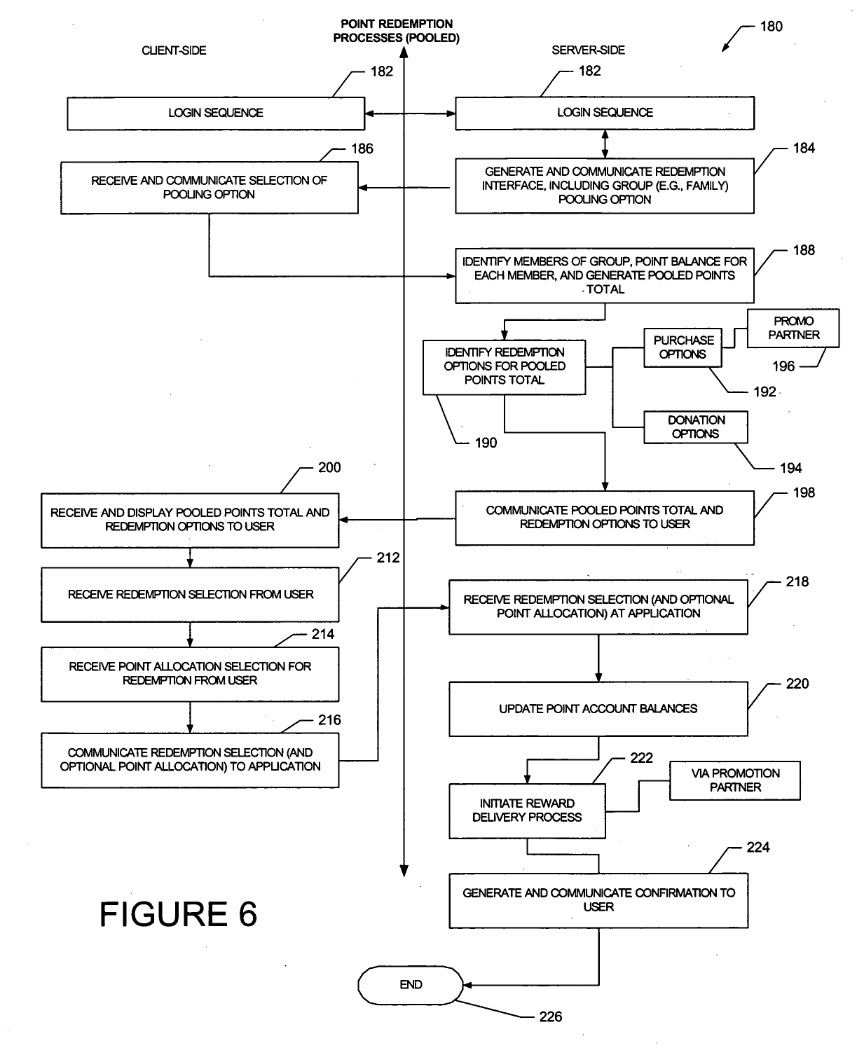

FIG. 6 is a flow chart illustrating a method 180, according to an exemplary embodiment, to redeem value (e.g., points, coupons, gift certificates accumulated) for goods or services. In one exemplary embodiment, the redemption is performed by the marketplace 12 so as to allow a user owning the accumulated value to exchange the accumulated value against goods and services that are offered for sale by via the marketplace 12.

The method 180 commences with a login sequence 182 to authenticate access privileges for the user to the marketplace 12.

At block 184, the loyalty/promotion application 82, and specifically the redemption module 86, generates and communicates redemption prompts, for example included within an interface, to the user. The redemption prompts include, inter alia, a group (e.g., a family) pooling option, whereby members of a group may pool accumulated value (e.g., points) for redemption or other purposes. In one embodiment, the prompts may enable the pooling of accumulated values pertaining to certain reward events or that originated from different sources. For example, a family may be presented with the option to pool points that they have accumulated as a result of reading books, and a further option to pool points they may have received as a result of weight loss events. Further, the user may be presented with the option of values that originated from different sources (e.g., to pool points, coupons and/or gift certificates).

In another embodiment, the option to pool points may not distinguish between points accumulated as a result of different activity types or that originate from different sources. For example, a family may be presented with the option to pool points that have been acquired through purchase activities and non-purchase activities into a single redemption value.

At block 186, the selection of the pooling option, communicated at block 184, is received from a user, and communicated from the client side (e.g., by a client machine 20) to the server side (e.g., the marketplace 12).

In one embodiment, responsive to receipt of the pooling option, at block 188, the redemption module 86 of the loyalty/promotion applications 82 performs a lookup to identify members of the relevant group. Specifically, during the login sequence 182, a user identifier is registered on the server side with respect to a relevant user. Utilizing this identifier, the redemption module 86 is able to identify a group to which the logged-in user belongs, and then to identify other users that belong to the relevant group by performing a read (e.g., of the family table 10). Having identified each member of a group, the redemption module 186 then identifies the point balance for each such member. For example, where the members of the group belong to a particular family, utilizing the family identifier is retrieved from the family table 110, the redemption module 86 is able to perform a lookup, utilizing the lookup process, on the user-points table 108 to identify point totals (or balances) for each user. Having then identified the points total for each member of a group, the redemption module 86 generates at least one pooled value for the group (e.g., at least one pooled points total). As described above, where the relevant promotional loyalty program differentiates between types of activities that constitute reward events, in one embodiment, multiple pooled values may be generated for the group, each of the pooled values (e.g., pooled points totaled), being associated with a particular activity or event type. For example, a family may have pooled points total for reading activities, and a pooled points total for weight loss activities, in addition to a pooled points total for purchase activities.

Moving on to block 190, the redemption module 86 then identifies a number of redemption options for the pooled points total. The redemption module 86 may identify a number of purchase options that are available for purchase utilizing the pooled points totaled or against which the pooled points total can be applied. To this end, the redemption module 86 may search the items table 94, discussed above with reference to FIG. 3, to identify items for which the accumulated value, represented by the pooled points total, may be exchanged. Alternatively, the purchase options may be limited to items (e.g., goods and services) that are offered by a promotions (or loyalty) partner in exchange for the accumulated value. For example, a particular retailer or company may offer a limited set of branded merchandise that can be purchased utilizing using the accumulated value. In this embodiment, the redemption module 86 may perform a search of items offered by a promotions (or loyalty) partner that have a value equal to or less than the accumulated value, and only identify these items as redemption options to the user.

The redemption options presented may also include one or more donation options 194. For example, a user may be presented with the option of donating the accumulated value, or some item that is redeemed utilizing the accumulated value (to a charitable cause or another identified recipient). For example, a user may elect to donate the pooled points total to a school that is attended by children belonging to the relevant family. In this embodiment, the school, as the recipient of accumulated values from a number of users, or groups of users, may redeem these values for purchases for the school.

Having identified the redemption options at block 190, at block 198 the pooled points total (or totals) and the identified redemption options are communicated from the server-side to the client-side, for example as one or more mark-up language documents to be presented as interfaces to the user. At block 200, the pooled points total (or totals) and the redemption options are displayed to the user.

FIG. 9 illustrates an exemplary interface 200 that may be presented to a user at block 200. The interface 200 is shown to reflect an individual points balance 204 for the logged-in user, as well as a group points balance 208 for a particular group to which the user belong. Where the user belongs to multiple groups, the group points balances for each of these groups may be displayed. The interface 202 also includes a link 206, which is user-selectable, to view redemption options available for the individual points balance, and a further link 210 that is user-selectable to view redemption options for the group points balance. Each of these links, it will be appreciated, may present a different set of redemption options in view of the different values of the relevant balances.

Returning to FIG. 6, at block 212, a redemption selection is received from the user, for example via an appropriate interface. A user may select one or more items from a list of potential items or recipients of the accumulated value.

At block 214, a point allocation selection option is received from the user. For example, where the user wishes to redeem a certain portion of the accumulated value against a certain redemption option, and another portion of the accumulated value against another redemption option, the user may be presented with the ability to specify such an allocation through an appropriate interface. Consider the situation where a family has children at multiple schools, and wishes to donate a portion of the pooled value to each of the multiple schools. In terms of the point allocation selection, the family is able to divide and allocate the accumulated value between the multiple schools. For example, the point allocation selection may identify a specific amount of the accumulated value as being allocated to each of a number of recipients, or may specify percentages of the accumulated value to be allocated to identified recipients. To this end, a user interface may allow a user to identify specific amounts, or percentages, to be allocated in a convenient manner.

At block 216, the redemption selection, and optionally the point allocation, is communicated from the client-side to the server-side, and specifically to the redemption module 86.

The communicated information is received on the server-side at block 218, whereafter the redemption module 86, at block 220, proceeds to update the point account balances of the members of the group. In one embodiment, the redeemed value may be evenly divided and subtracted from the balances of the accounts of the members of the group. In an alternative embodiment, the redeemed value may be divided amongst the members of the group according to a specific criterion (e.g., a current balance, age, etc.), and a portion of the redeemed value so calculated is then subtracted from the balance of each member.

Moving on to block 222, the redemption module 86 then initiates a reward delivery process whereby the item (e.g., goods and services) for which the accumulated value was redeemed (or against which the accumulated value was applied) is delivered to the redeeming user, or to another recipient identified by the redeeming user. Where an item for which the accumulated value was redeemed is supplied by the promotional partner (e.g., branded merchandise), the initiation of the reward delivery process involves communications with this partner to instruct the relevant delivery.

At block 224, a confirmation is generated and communicated to the user, for example, as a confirmation user interface that is presented to the user. The method 180 then ends at end block 226.

While the method 180 has been described above as pertaining to the redemption of a pooled accumulated value, it will be appreciated that certain aspects of the method 180 do not require that a pooled accumulated value be redeemed, and could apply where the accumulated value for a single user is redeemed. For example, the identification of redemption options that is performed at block 190, and the point allocation described with reference to block 214, may be implemented in a redemption process that operates on an individual accumulated value, as opposed to a pooled accumulated value.

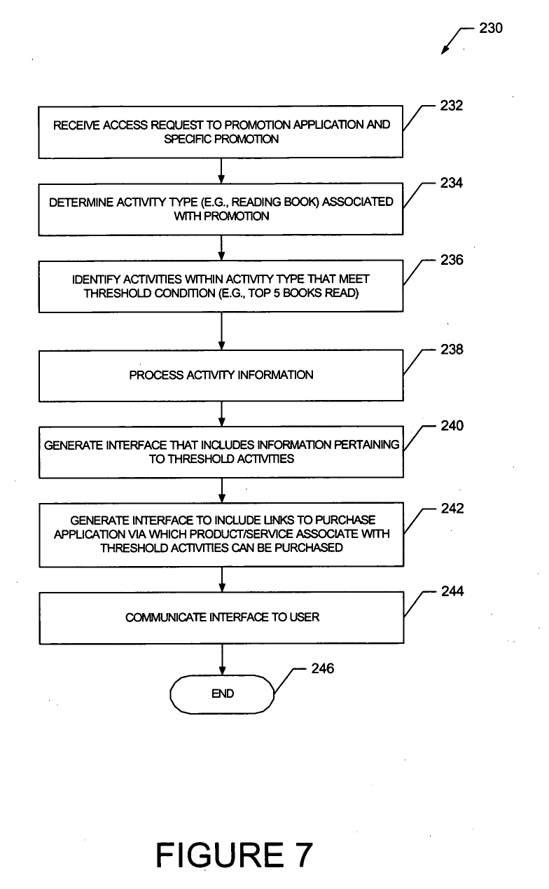

FIG. 7 is a flow chart illustrating a method 230, according to an exemplary embodiment, to communicate activity information, pertaining to a loyalty/promotion program. Specifically, in one embodiment, the method 230 may be performed by a statistics module 88, which forms part of the loyalty/promotions applications 82.

The method 230 commences at block 232 with the receipt of an access request, for example, at the marketplace 12, to a promotion program 82 that supports a particular promotion. For example, a particular company may be operating a promotion (or loyalty) program in conjunction with an operator of the marketplace 12. The operator of the marketplace 12 may, in this scenario, create a web site that is dedicated to the relevant promotion campaign, and the access request received at block 232, may be in the form of a Uniform Resource Locator (URL) that identifies the web site.

At block 234, the statistics module 88 determines a particular activity type (e.g., book reading) that is associated with the promotion. In one embodiment, a number of activity types, identified in the activity type table 116, may be associated with a single promotion. In another embodiment, a single activity type may be associated with a promotion.

At block 236, the statistics module 88 then identifies activities within the relevant activity type that meet a predetermined criteria (e.g., a maximum or minimum threshold condition). For example, where the activity type was determined at block 234 to be book reading, at block 236 the statistics module 88 may, by performing an appropriate lookup on the activity table 112, identify all book reading activities. Having identified these book reading activities, the statistics module 88 may then determine that the top 10 books that are currently being read by participants in the promotional campaign. A wide variety of activities could be identified as meeting predetermined conditions. For example, for a weight loss promotional example, the statistics module 88 identifies reward events where participants have lost a predetermined amount of weight (e.g., reduced their weight by 20%).

At block 240, the statistics module 88 then proceeds to process activity information associated with the identified activities to generate statistics. For example, the statistics module 88 may identify the top 10 books that are being read, as well as a percentage of participants that have read each of the top 10 books. In the weight loss example, the statistics module 88 may calculate a percentage of participants that have lost predetermined amounts of weight (e.g., 10% of participants that have 20% of weight, 15% of participants have lost 5% of weight, etc.).

At block 240, the statistics module 88, in conjunction with the web server 26, generates an interface that includes information pertaining to the activity level identified at block 236. For example, the interface may include statistical information generated at block 238.

At block 242, the loyalty/promotion applications 82, in conjunction with the web server 26, generate the interface to include links to a purchase application, via which products or services associated with the threshold activities can optionally be purchased. Accordingly, the links represent purchase opportunities that are included within the interface, and that are presented to the user. For example, a link to an appropriate purchase application (e.g., an auction application 44 or a fixed-price application 46) can be generated and inserted into the user interface adjacent the title of each of the books that was identified as being included in the “Top 10” books currently being read by participants of a promotional program.

In alternative embodiments, the links that are associated with the information pertaining to the threshold activities need not be to a purchase opportunity, but could be to other information sources pertaining to the threshold activities. Considering the weight loss example, a link adjacent information identifying the percentage of people that have lost the greatest percentage of weight could be a link to a dietary information or published tips provided by the users regarding weight loss.

At block 244, the generated interface is communicated to a user, whereafter the method 230 terminates at end block 246.

FIG. 9 illustrates the interface 202 as including information pertaining to the threshold activities, in the exemplary form of a list 248 of the top books currently being read by participants within a particular promotional program.

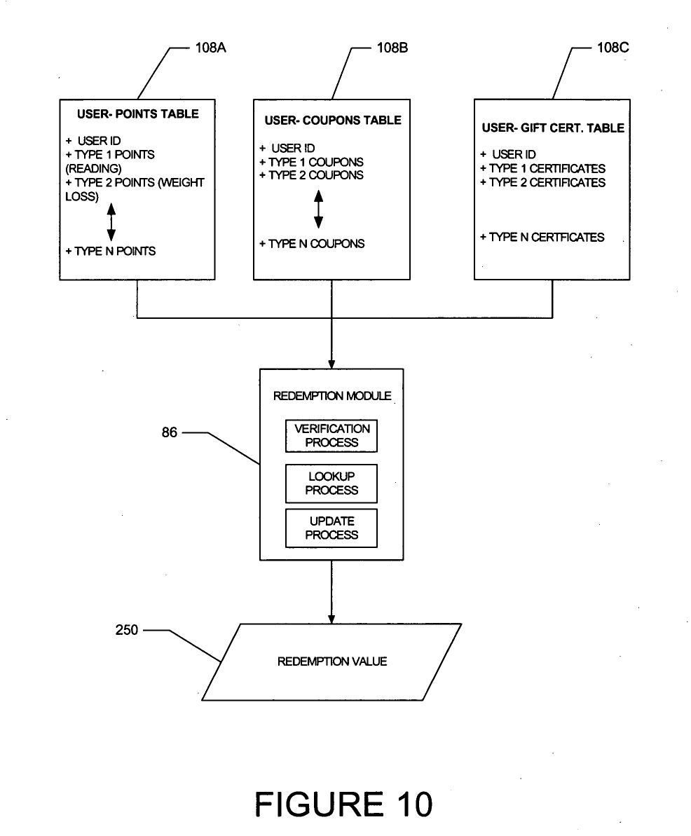

FIG. 10 is a diagrammatic depiction of a lookup that may be performed by a lookup process of the redemption module 86, against the user-points table 108A, the user-coupons table 108B, and the user-gift certificates table 108C to identify any one or more of these exemplary types of value that may have been allocated to (or attributed to or collected by) a specific user. FIG. 10 also illustrates conceptually that the redemption module 86 may combine the different value types, associated with a particular user and retrieved from the tables 180A-108C, into a single redemption value 250, which may for example be redeemed against a single purchase price.

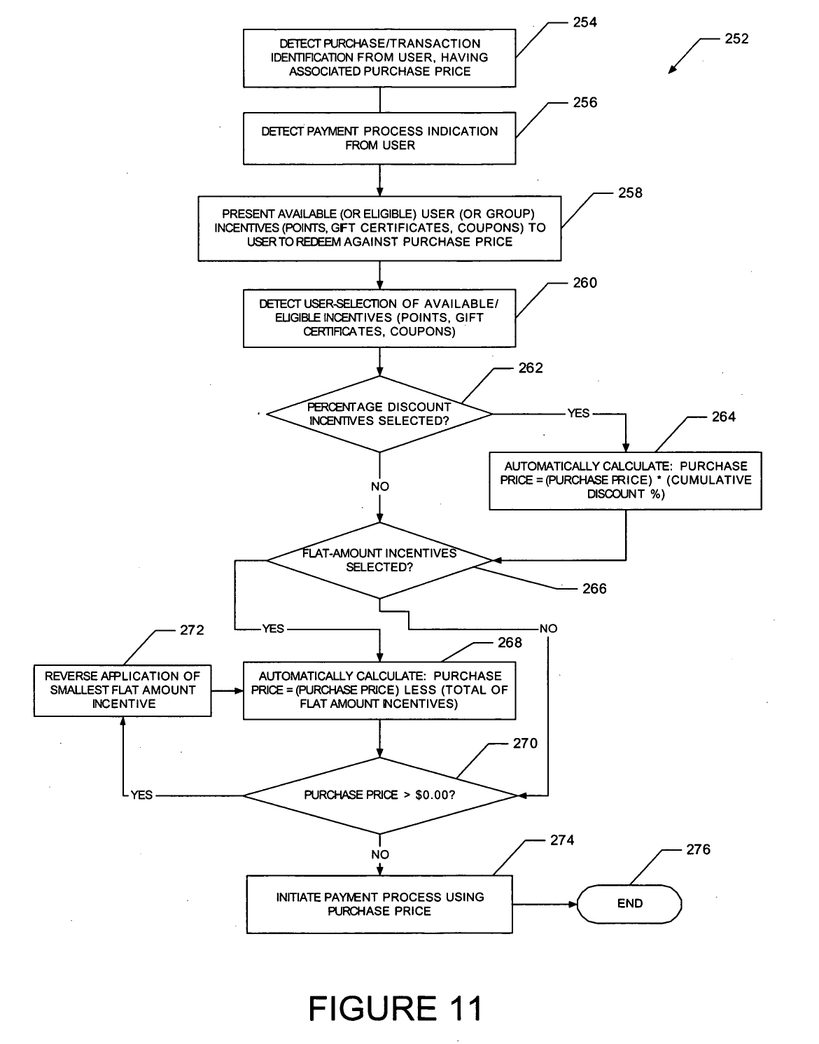

FIG. 11 is a flowchart illustrating a method 252, according to an exemplary embodiment, to facilitate redemption of value that is comprised of multiple value types. The method 252 commences at block 254, with the detection of a purchase (or transaction) identification from a user, the identified purchase (or transaction) having an associated purchase price. For example, by navigating the network-based marketplace 12, a user may have identified one or more items that are being offered for sale, each of these identified items having a respective purchase price. The user may communicate an identification of items in which the user has an interest, for example, by adding the relevant items to a virtual shopping cart, or by providing a “buy” communication with respect to a particular item.

At block 256, the payment/redemption applications 32 detect the initiation of a payment process by the user. For example, the user may initiate a “check out” process supported by the payment/redemption applications 32, or may initiate a payment flow with respect to an item offered for sale via the marketplace applications 30.

At block 258, the redemption module 86 proceeds to present available (or eligible) values, of multiple value types, to a user for selection and redemption (e.g., the purchase price determined at block 254). The available (or eligible) values may be incentive values, in the exemplary form of points, coupons or gift certificates that are identified as having been allocated (or attributed) to the user in the tables 108A-108C. In one embodiment, in addition to presenting incentive values associated with the user as an individual, incentive values that are available to the user, as a result of the user's membership of a particular group, may also be presented to the user for selection.

The determination whether a particular value, of a particular value type, is eligible for redemption against the purchase price may, in various embodiments, involve an analysis of the item or service with which the purchase price is associated. For example, a particular value type (e.g., points or coupons) may only be redeemable against the purchase price of selected items available for purchase via the network-based marketplace 12. Other restrictions may also apply with respect to various purchase prices. For example, gift certificates may only be redeemable against purchases in certain qualifying “virtual” stores supported by the network-based marketplace 12. Time restrictions may also exist with respect to coupons or points that are allocated to a user. For example, coupons or points may expire after a predetermined time period, and thus be unavailable for redemption against the purchase price at block 258.

At block 260, the redemption module 86 detects user selection of one or more available (or eligible) values, of varying value types (e.g., points, gift certificates, coupons, etc.). At decision block 262, a determination is made whether any of the user-selected value types comprises a percentage discount incentive. If so, at block 264, the redemption module 86 performs an automatic calculation to generate a revised purchase price by reducing the original purchase price by the percentage discount incentive (e.g., the original purchase price is discounted by 10% to generate a revised purchase price).

Following a negative determination at block 262, or following completion of the operation at block 264, at decision block 266, a determination is made whether any of the user-selected values constitute a flat amount incentive (e.g., $10 off the purchase price). If so, at block 268, the redemption module 86 proceeds automatically to calculate a further revised purchase price by subtracting a total of the user-selected flat-amount incentives from the original (or revised) purchase price to generate the further revised purchase price.

It will be noted that percentage discount incentives are applied, in one embodiment, prior to the application of the flat-amount incentives in order to maximize the discount that is provided to the user.

At decision block 270, a determination is made as to whether the further revised purchase price is less than $0.00. If so, this indicates that an excessive number of flat-amount incentives may have been applied against the purchase price. Accordingly, at block 272, the redemption module 86 reverses application of a smallest flat-amount incentive that was applied at block 268. Having reversed the application of a smallest flat-amount incentive, the method 252 then loops back to block 268, where the further revised purchase prices is again recalculated, without applying the identified smallest flat-amount incentive. The method 252 loops through blocks 268, decision block 270, and block 272, until the purchase price is equal to, or exceeds $0.00.

Having now discounted the purchase price (e.g., utilizing percentage discount incentives and flat-amount incentives), a payment process, for payment of the further revised purchase price by the user to one or more sellers, is initiated at block 274, whereafter the method 252 terminates at block 276.

In various embodiments, the discounts that are applied at blocks 264 and block 268 may furthermore be attributed to sponsoring parties. For example, where a particular “virtual” store supported by the network-based marketplace 12 is offering the coupons, the redemption module 86 may debit a “coupon” account of the relevant virtual store so as to pass the costs of the discount on to the sponsoring virtual store.

It will be appreciated that, in one embodiment, the points, gift certificates, and coupons discussed above may be viewed as values of different types. However, in other embodiments, other value types may be combined for redemption against a single purchase price.

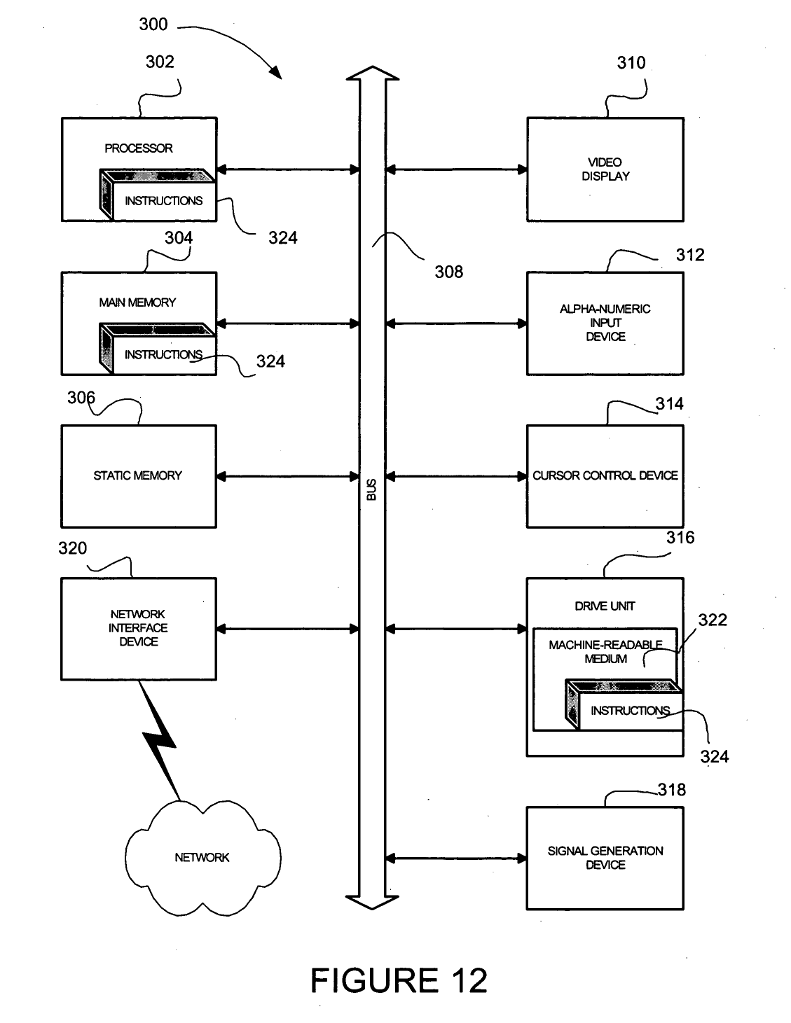

FIG. 12 shows a diagrammatic representation of machine in the exemplary form of a computer system 300 within which a set of instructions, for causing the machine to perform any one or more of the methodologies discussed herein, may be executed. In various embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

1. An automated system to facilitate a redemption of value against a single purchase price, the system including:
a first module to allocate a first value, of a first value type, to a user within a transaction system, and to allocate a second value, of second value type different from the first value type, to the user within the transaction system; and
a second module to enable the user to redeem both the first value and the second value against the single purchase price.

2. The system of claim 1, wherein each of the first and the second value types is an incentive value type.

3. The system of claim 2, wherein the incentive value type is any one of a group of incentive value types, including a point, gift certificate and coupon value type.

4. The system of claim 1, wherein the first value is a flat discount value and the second value is a percentage value discount.

5. The system of claim 4, wherein the second module is to apply the percentage discount value against the purchase price to generate a first discounted purchase price, and to apply the flat discount value against the first discounted price to generate a second discounted purchase price.

6. The system of claim 5, wherein the second module is to apply a plurality of flat discount values against the first discounted purchase price to generate the second discounted price, to determine whether the second discounted purchase price transgresses a threshold and, if so, then to reverse the application of at least one of the plurality of flat discount values until the second discounted purchase price does not exceed the threshold.

7. The system of claim 1, wherein the second module is to present the user with a plurality of values for redemption against the purchase price, and to detect user-selection of the first and second values for redemption against the purchase price.

8. An automated method to facilitate a redemption of value against a single purchase price, the method including:
allocating a first value, of a first value type, to a user within a transaction system;
allocating a second value, of second value type different from the first value type, to the user within the transaction system; and
enabling the user to redeem both the first value and the second value against the single purchase price.

9. The method of claim 8, wherein each of the first and the second value types is an incentive value type.

10. The method of claim 9, wherein the incentive value type is any one of a group of incentive value types, including a point, gift certificate and coupon value type.

11. The method of claim 8, wherein the first value is a flat discount value and the second value is a percentage value discount.

12. The method of claim 11, wherein the enabling includes applying the percentage discount value against the purchase price to generate a first discounted purchase price, and applying the flat discount value against the first discounted price to generate a second discounted purchase price.

13. The method of claim 12, including applying a plurality of flat discount values against the first discounted purchase price to generate the second discounted price, determining whether the second discounted purchase price transgresses a threshold and, if so, then reversing the application of at least one of the plurality of flat discount values until the second discounted purchase price does not exceed the threshold.

14. The method of claim 8, wherein the redeeming includes presenting the user with a plurality of values for redemption against the purchase price, and detecting user-selection of the first and second values for redemption against the purchase price.

15. An automated system to facilitate accumulation of value in an account of a user, the system including:
an accumulation module to receive, from a user, first activity information regarding a first activity performed by the user and responsive to receipt of the first activity information, to allocate a first value of a first value type to an account associated with the user; and to receive, from the user, second activity information regarding a second activity performed by the user and responsive to receipt of the second activity information, to allocate a second value of a second value type to the account associated with the user, the first and second value types being different value types; and
a redemption module to enable the user to redeem the first and second values against a single purchase price.

16. The system of claim 15, wherein the first activity is a purchase activity.

17. The system of claim 16, wherein the first activity information includes verifiable purchase information.

18. The system of claim 15, including a loyalty system to associate a promotional code with a purchase opportunity, and wherein the first activity information includes the promotional code associated with the purchase opportunity to which the purchase activity relates.

19. The system of claim 15, wherein the second activity is a non-purchase activity.

20. The system of claim 19, wherein the second activity is any one of a group of activities including a reading activity, and a weight loss activity.

21. The system of claim 15, wherein the second activity information includes a product identifier to identify a product relating to the second activity.

22. The system of claim 21, wherein the second activity includes reading a book, and the product identifier comprises an ISBN code of the book.

23. The system of claim 21, wherein product identifier includes any one of a group of product identifiers including a Universal Product Code (UPC), an EAN code, and an EPC code.

24. The system of claim 15, wherein the first activity is a purchase-related activity, and the second activity is a nonpurchase-related activity.

25. The system of claim 15, wherein the accumulation module is to perform a lookup, within a memory structure, to determine the first value, the lookup being performed utilizing the first activity information.

26. The system of claim 25, wherein the first activity information includes a product identifier, and wherein the lookup includes identifying the first value as being associated with a product identified by the product identifier.

27. The system of claim 15, wherein the accumulation module is to perform a lookup, within a memory structure, to determine the second value, the lookup being performed utilizing the second activity information.

28. The system of claim 15, wherein the accumulation module is to update an account value, stored within a memory structure, to include the respective first and second values.

29. The system of claim 15, wherein at least one of the first and second values is a proprietary currency.

30. The system of claim 29, wherein the proprietary currency is a point-based currency.

31. The system of claim 15, wherein the accumulation module is to make no distinction between the first and second values once allocated to the account associated with the user.

32. The system of claim 15, wherein the first and second values are distinguishable once allocated to the account of the user.

33. The system of claim 15, including a statistics module to track at least second activity information as received from a plurality of users, and to calculate statistical information regarding performance of the second activity by the plurality of users.

34. The system of claim 33, wherein the statistical information includes product information identifying at least one product associated with the second activity.

35. The system of claim 34, wherein the statistics module is to communicate the statistical information, including the product information, to a further user.

36. The system of claim 35, wherein the product information is communicated in conjunction with purchase opportunity information so as to present a purchase opportunity relating to the product identified by the product information to the further user.

37. An automated method to facilitate accumulation of value in an account of a user, the method including:
receiving, from a user, first activity information regarding a first activity performed by the user;
responsive to receipt of the first activity information, allocating a first value of a first value type to an account associated with the user;
receiving, from the user, second activity information regarding a second activity performed by the user;
responsive to receipt of the second activity information, allocating a second value of a second value type to an account associated with the user, the first and second value types being different value types; and
enabling the user to redeem the first and second values against a single purchase price.

38. The method of claim 37, wherein the first activity is a purchase activity.

39. The method of claim 38, wherein the first activity information includes verifiable purchase information.

40. The method of claim 37, including prior to the purchase activity, associating a promotional code with a purchase opportunity, and wherein the first activity information includes the promotional code associated with the purchase opportunity to which the purchase activity relates.

41. The method of claim 37, wherein the second activity is a non-purchase activity.

42. The method of claim 41, wherein the second activity is any one of a group of activities including a reading activity, and a weight loss activity.

43. The method of claim 37, wherein the second activity information includes a product identifier to identify a product relating to the second activity.

44. The method of claim 43, wherein the second activity includes reading a book, and the product identifier comprises an ISBN code of the book.

45. The method of claim 43, wherein product identifier includes any one of a group of product identifiers including a Universal Product Code (UPC), an EAN code, and an EPC code.

46. The method of claim 37, wherein the first activity is a purchase-related activity, and the second activity is a nonpurchase-related activity.

47. The method of claim 37, wherein the allocation of the first value to the account associated with the user includes performing a lookup, within a memory structure, to determine the first value, the lookup being performed utilizing the first activity information.

48. The method of claim 47, wherein the first activity information includes a product identifier, and wherein the lookup includes identifying the first value as being associated with a product identified by the product identifier.

49. The method of claim 37, wherein the allocation of the second value to the account associated with the user includes performing a lookup, within a memory structure, to determine the second value, the lookup being performed utilizing the second activity information.

50. The method of claim 37, wherein the allocation of each of the first and second values to the account associated with the user includes updating an account value, stored within a memory structure, to include the respective first and second values.

51. The method of claim 37, wherein at least one of the first and second values is a proprietary currency.

52. The method of claim 51, wherein the proprietary currency is a point-based currency.

53. The method of claim 37, wherein no distinction is made between the first and second values once allocated to the account associated with the user.

54. The method of claim 37, wherein the first and second values are distinguishable once allocated to the account of the user.

55. The method of claim 37, including tracking at least second activity information as received from a plurality of users, and calculating statistical information regarding performance of the second activity by the plurality of users.

56. The method of claim 55, wherein the statistical information includes product information identifying at least one product associated with the second activity.

57. The method of claim 56, including communicating the statistical information, including the product information, to a further user.

58. The method of claim 57, wherein the product information is communicated in conjunction with purchase opportunity information so as to present a purchase opportunity relating to the product identified by the product information to the further user.

59. An automated system to facilitate a redemption of value against a purchase price, the system including:
first means for allocating a first value, of a first value type, to a user within a transaction system, and for allocating a second value, of second value type different from the first value type, to the user within the transaction system; and
second means for enabling the user to redeem both the first value and the second value against the purchase price.

60. An automated system to facilitate accumulation of value in an account of a user, the system including:
first means for receiving from a user, first activity information regarding a first activity performed by the user and responsive to receipt of the first activity information, for allocating a first value of a first value type to an account associated with the user; and for receiving, from the user, second activity information regarding a second activity performed by the user and responsive to receipt of the second activity information, for allocating a second value of a second value type to the account associated with the user, the first and second value types being different value types; and
second means for enabling the user to redeem the first and second values against a single purchase price.

61. A machine-readable medium storing a set of instructions that, when executed by a machine, cause the machine to perform an automated method to facilitate a redemption of value against a purchase price, the method including:
allocating a first value, of a first value type, to a user within a transaction system;
allocating a second value, of second value type different from the first value type, to the user within the transaction system; and
enabling the user to redeem both the first value and the second value against the purchase price.

62. A machine-readable medium storing a set of instructions that, when executed by a machine, cause the machine to perform an automated method to facilitate accumulation of value in an account of a user, the method including:
receiving, from a user, first activity information regarding a first activity performed by the user;
responsive to receipt of the first activity information, allocating a first value of a first value type to an account associated with the user;
receiving, from the user, second activity information regarding a second activity performed by the user;
responsive to receipt of the second activity information, allocating a second value of a second value type to an account associated with the user, the first and second value types being different value types; and
enabling the user to redeem the first and second values against a single purchase price.
